(19) United States
(12) Patent Application Publication
(10) Pub. No.: US 2009/0262847 A1
(43) Pub. Date: Oct. 22, 2009

(54) Orthogonal Frequency Division Multiplexing Receiver for Minimizing Inter-Symbol Interference

(75) Inventor: Yung-Hoon Jo, Kyungki-do (KR)

Correspondence Address: FISH & RICHARDSON, PC, P.O. BOX 1022, MINNEAPOLIS, MN, 55440-1022, US

(73) Assignee: CORE LOGIC, INC., Seoul (KR)

(21) Appl. No.: 12/425,902

(22) Filed: Apr. 17, 2009

(30) Foreign Application Priority Data
Apr. 17, 2008 (KR) 1020080035811

(51) Int. Cl. H04K 1/10; H04J 11/00

(52) U.S. Cl. 375/260; 370/203

(57) ABSTRACT

Techniques, apparatus, and systems are described for providing an orthogonal frequency division multiplexing (OFDM) receiving apparatus. An orthogonal frequency division multiplexing (OFDM) receiving apparatus includes a fast Fourier transform (FFT) start point estimating unit to detect a minimum symbol interference point of a received OFDM signal and identify a FFT start point. The apparatus includes a FFT operation performing unit to communicate with the FFT start point estimating unit and to perform a FFT operation at the FFT start point identified by the FFT start point estimating unit. The apparatus includes a phase modifying unit to communicate with the FFT start point estimating unit and to modify a phase of an output of the FFT operation performing unit. Also, the apparatus includes a decoding unit to communicate with the FFT operation performing unit and to decode the phase modified output of the FFT operation performing unit.

### CLAIM OF PRIORITY

This application claims the benefit of Korean Patent Application No. 10-2008-0035811, filed on Apr. 17, 2008, in the Korean Intellectual Property Office, the disclosure of which is incorporated herein in its entirety by reference.

### BACKGROUND

The present disclosure relates to an orthogonal frequency division multiplexing (OFDM) communication system.

When an orthogonal frequency division multiplexing (OFDM) model is designed, symbol synchronization is obtained at a minimum inter-symbol interference (ISI) point, which is directly related to the performance of modems. Points of discontinuity in a phase occur between symbols having different information, and fast Fourier transform (FFT) in a section including the points of discontinuity involves spreading constellation in spite of an excellent signal to noise rate (SNR). Additional symbols, which are guard symbols, are used to extend the phase of symbols.

FFT is performed within a range of the guard symbol beyond the points of discontinuity in the phase. However, multipath fading occurs in a channel environment and thus lengths causing the ISI become different due to fading. Thus, FFT may be performed at the minimum ISI point in view of the performance of modems.

To perform FFT at the minimum ISI point, FFT can be performed before a predetermined sample at a maximum impulse response point according to a quantitative experiment. However, this does not always guarantee the same performance under all the conditions.

Alternatively, the ISI can be removed by previously storing samples longer than symbols and covering symbols having the same samples as guard symbols with samples at a minimum symbol interference point and a maximum impulse response point. This can provide high performance of removing the ISI, which requires additional storage device and register for previously storing guard samples, and thus area efficiency is reduced.

FIG. 1 is a conceptual view diagram 100 for explaining a conventional ISI removing method. Referring to FIG. 1, FFT is performed on an OFDM symbol that is divided into a guard symbol period, Tg, and a valid symbol period, Tu, by a length of the valid symbol period Tu from a symbol timing synchronization point. However, when FFT is performed, a symbol start point is erroneously determined in a channel environment including a multipath, and a next symbol partly overlaps an end part of the OFDM symbol, i.e. an ISI.

To remove the ISI, FFT is performed after copying a predetermined period, Tp, of a front part of the OFDM symbol and covering the part in which the ISI occurs with the predetermined period Tp. Samples in the predetermined period Tp correspond to a protection period that is a part of the valid symbol period Tu copied by a transmission side, i.e. a guard symbol period Tg. Thus, the samples in the predetermined period Tp have the same as samples of a part for which FFT is to be performed. FFT is performed on the predetermined period Tp, instead of the period where the ISI occurs, thereby preventing the occurrence of the ISI. The predetermined period Tp is shorter than the guard symbol period Tg, and may be determined according to the channel environment.

FIG. 2 is a conceptual view diagram 200 for explaining a conventional FFT operation process with respect to the OFDM symbol according to the method shown in FIG. 1. Referring to FIG. 2, an FFT operation is performed on a dotted period including the predetermined period Tp and excluding the end part of the valid symbol period Tu from the symbol timing synchronization point.

However, as described above, the conventional method of copying the guard symbol period Tg needs additional storage device and register for storing guard samples of a predetermined period, which reduces area efficiency in realizing an OFDM receiving apparatus.

### SUMMARY OF THE DISCLOSURE

The present disclosure provides an orthogonal frequency division multiplexing (OFDM) receiving apparatus for efficiently removing an inter-symbol interference (ISI) by actively handling a channel change while not reducing area efficiency due to additional storage device and register, and a method of minimizing the ISI using the OFDM receiving apparatus.

In one aspect, an orthogonal frequency division multiplexing (OFDM) receiving apparatus includes a fast Fourier transform (FFT) start point estimating unit to detect a minimum symbol interference point of a received OFDM signal and identify a FFT start point. The apparatus includes a FFT operation performing unit to communicate with the FFT start point estimating unit and to perform a FFT operation at the FFT start point identified by the FFT start point estimating unit. The apparatus includes a phase modifying unit to communicate with the FFT start point estimating unit and to modify a phase of an output of the FFT operation performing unit. Also, the apparatus includes a decoding unit to communicate with the FFT operation performing unit and to decode the phase modified output of the FFT operation performing unit. An inter-symbol interference (ISI) in the decoded output of the FFT operation performing unit having the modified phase is minimized in comparison to the received OFDM signal.

Implementations can optionally include one or more of the following features. The apparatus can includes a maximum impulse response estimating unit to communicate with the FFT start point estimating unit to search for a maximum impulse response point in the OFDM signal. The FFT start point estimating unit can include a bit error rate (BER) calculating unit to receive an output of the decoding unit and calculate a BER of the output of the decoding unit. The FFT start point estimating unit can include a symbol timing shift estimating unit to communicate with the BER calculating unit and the maximum impulse response point estimating unit to receive the maximum impulse response point and an output of the BER calculating unit and estimate a symbol timing shift representing a time difference between the maximum impulse response point and the minimum symbol interference point. The FFT start point estimating unit can include a FFT start point adjusting unit to communicate with the symbol timing shift estimating unit to receive an output of the symbol timing shift estimating unit and adjust the FFT start point of the FFT operation performing unit. The FFT start point estimating unit can be configured to detect the minimum symbol interference point by using the calculated BER.

Implementations can optionally include one or more of the following features. The phase modifying unit can include a subcarrier index generating unit to generate an index of a subcarrier. The phase modifying unit can include a numerically controlled oscillator (NCO) to generate a phase modifying signal using a value obtained by multiplying an output of the symbol timing shift estimating unit and an output of the subcarrier index generating unit as an address value. The generated phase modifying signal can include a sine wave. The phase modifying unit modifies the phase of the output of the FFT operation performing unit by multiplying a complex conjugate of the generated phase modifying signal with the output of the FFT operating performing unit. The generated phase modifying signal used to modify the phase of the output of the FFT operation performing unit is generated based on a clock signal that is higher than a sampling clock signal; and the generated phase modifying signal is used to remove a frequency shift of the received OFDM signal. When the FFT start point is initially identified, the FFT start point estimating unit estimates a point before the maximum impulse response point of the OFDM signal by using a predetermined period of a guard symbol as the FFT start point. The FFT start point estimating unit is configured to actively detect the minimum symbol interference point in response to a channel change through a feedback operation. The apparatus can include a baseband converting unit to convert the OFDM signal into a baseband signal. The apparatus can include an interpolation filtering unit to communicate with the baseband converting unit and the FFT operation performing unit, wherein the interpolation filtering unit is configured to sample an output of the baseband converting unit and input the sampled output into the FFT operation performing unit. The apparatus can include a clock error estimating unit to estimate a clock error of the phase modified output of the FFT operation performing unit. The decoding unit can include a channel equalizing unit to compensate for characteristics of a distorted channel in the phase modified output of the FFT performing unit. The decoding unit can include a Viterbi decoding unit to communicate with the channel equalization unit to decode an output of the channel equalization unit using a convolution code. The decoding unit can include a Reed-Solomon decoding unit to communicate with the Viterbi decoding unit to decode an output of the Viterbi unit using a Reed-Solomon code.

In another aspect, a method of minimizing an inter-symbol interference (ISI) includes detecting, at a maximum impulse response estimating unit, a maximum impulse response point of an orthogonal frequency division multiplexing (OFDM) signal. The method also includes estimating, at a fast Fourier transform (FFT) start point estimating unit, a minimum symbol interference point in the OFDM signal. Also the method includes performing, at a FFT operation performing unit, a FFT operation at the estimated minimum symbol interference point. Further, the method includes modifying a phase of an output of the FFT operation performing unit; and decoding, at a decoding unit, the phase modified output of the FFT performing unit.

Implementations can optionally include one or more of the following features. When initially performing the FFT operation, estimating, at the FFT start point estimating unit, a point before the maximum impulse response point of the OFDM signal by using a predetermined period of a guard symbol as the minimum symbol interference point. Modifying the phase can include generating a phase modifying signal and applying the generated phase modifying signal to the output of the FFT operation performing unit. The phase modifying signal can include a sine wave signal generated by an NCO using a value obtained by multiplying a symbol timing shift representing a time difference between the maximum impulse response point and the minimum symbol interference point and a subcarrier index used as an address value. A complex conjugate of the sine wave is multiplied with the output of the FFT operating performing unit. Modifying the phase can include using the sine wave to modify the phase, and generating the sine wave, at the NCO, by using a clock signal that is higher than a sampling clock signal. Decoding the phase modified output of the FFT performing unit can include compensating, at a channel equalizing unit, for characteristics of a distorted channel in the phase modified output of the FFT performing unit. Decoding the phase modified output of the FFT performing unit can include decoding, at a Viterbi decoding unit, an output of the channel equalizing unit by using a convolution code; and decoding, at a Reed-Solomon decoding unit, an output of the Viterbi decoding unit by using a Reed-Solomon code. After decoding the phase modified output of the FFT performing unit, calculating, at a bit error rate (BER) calculating unit, a BER of the output of the decoding unit. The method can include actively detecting the minimum symbol interference point in response to a channel change through a feedback operation that uses the BER calculated by the BER calculating unit in estimating the minimum symbol interference point. Before estimating the minimum symbol interference point, estimating at a symbol timing shift estimating unit can include estimating the symbol timing shift representing a time difference between the maximum impulse response point and the minimum symbol interference point. Also can include estimating the minimum symbol interference point using an output of the symbol timing shift estimating unit, and estimating the symbol timing shift using the outputs of the maximum impulse response estimating unit and the BER calculating unit.

The minimum symbol interference point in response to a channel change may be actively detected through a feedback operation that uses the calculation of the BER in the estimating of the minimum symbol interference point. Meanwhile, since the calculation of the BER cannot be used when the FFT operation is firstly performed, the FFT start point estimating unit may estimate a point before ¼ of the length of a guard symbol period from the maximum impulse response point of the OFDM signal as an initial FFT start point.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a conceptual view diagram for explaining a conventional inter-symbol interference (ISI) removing method;

FIG. 2 is a conceptual view diagram for explaining a conventional fast Fourier transform (FFT) operation process on an orthogonal frequency division multiplexing (OFDM) symbol according to the method shown in FIG. 1;

FIG. 3A is a block diagram of an OFDM receiving apparatus according to an embodiment of the present disclosure;

FIG. 3B is a detailed block diagram of the OFDM receiving apparatus shown in FIG. 3A;

FIG. 4 illustrates a maximum impulse response point and a minimum symbol interference point of an OFDM symbol;

FIG. 5 is a flowchart illustrating a method of minimizing an ISI according to an embodiment of the present disclosure;

FIG. 6 is a conceptual view diagram for explaining the phase rotation of an FFT operation output after a FFT operation is performed by periods based on a maximum impulse response point;

FIG. 7 is graphs showing a phase slope and cosine/sine waveforms corresponding to the phase slope when a symbol timing shift is 1;

FIGS. 8A and 8B are conceptual views diagrams for explaining a conventional method of removing an ISI and a method of removing the ISI according to an embodiment of the present disclosure, respectively; and

FIG. 9 is a graph showing a symbol error rate (SER) with respect to a signal to noise rate (SNR) when the method of removing the ISI of the present disclosure is applied and is not applied.

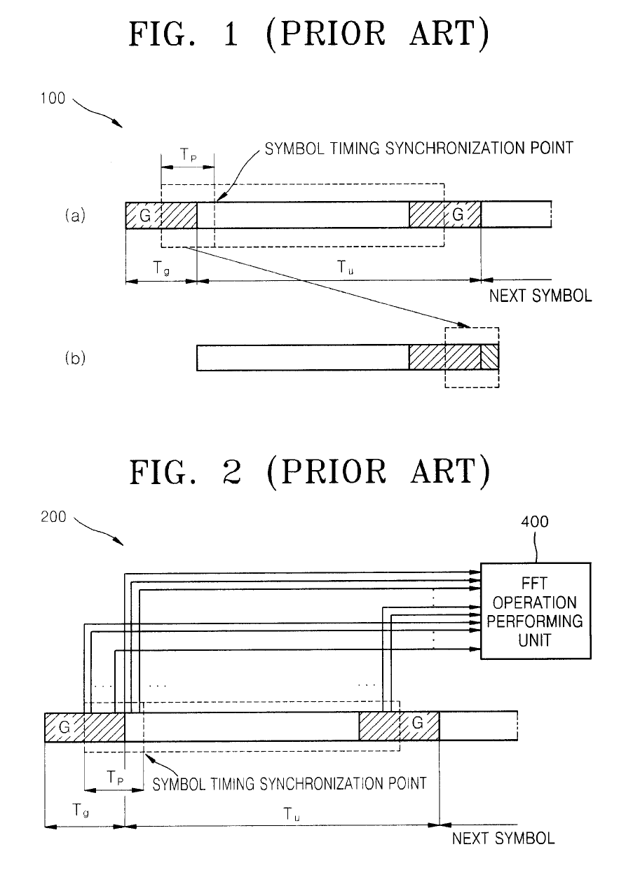

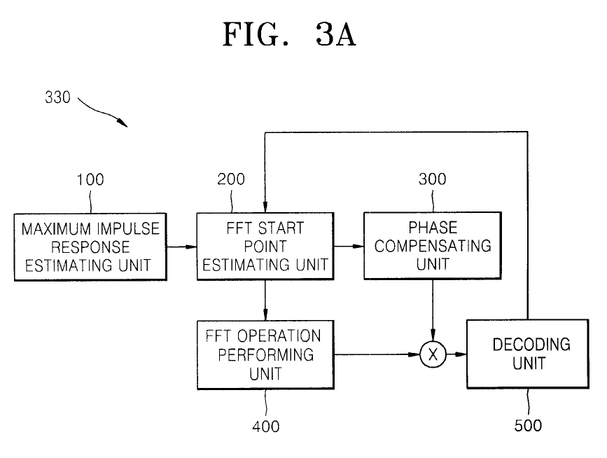

Like reference numerals denote like elements throughout.

### DETAILED DESCRIPTION

Techniques, apparatus and system are described for providing an orthogonal frequency division multiplexing (OFDM) receiving apparatus for efficiently removing an inter-symbol interference (ISI) by actively handling a channel change without using additional storage device and register.

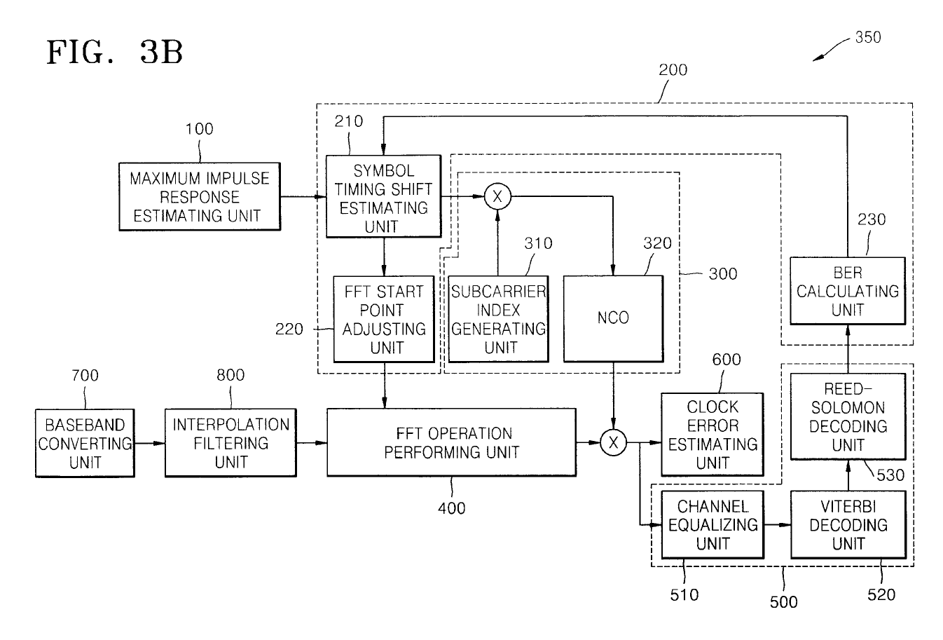

FIG. 3A is a block diagram 330 of an orthogonal frequency division multiplexing (OFDM) receiving apparatus according to an embodiment of the present disclosure. Referring to FIG. 3A, the OFDM receiving apparatus includes a maximum impulse response estimating unit 100, a fast Fourier transform (FFT) start point estimating unit 200, a phase modifying unit 300, a FFT operation performing unit 400, and a decoding unit 500.

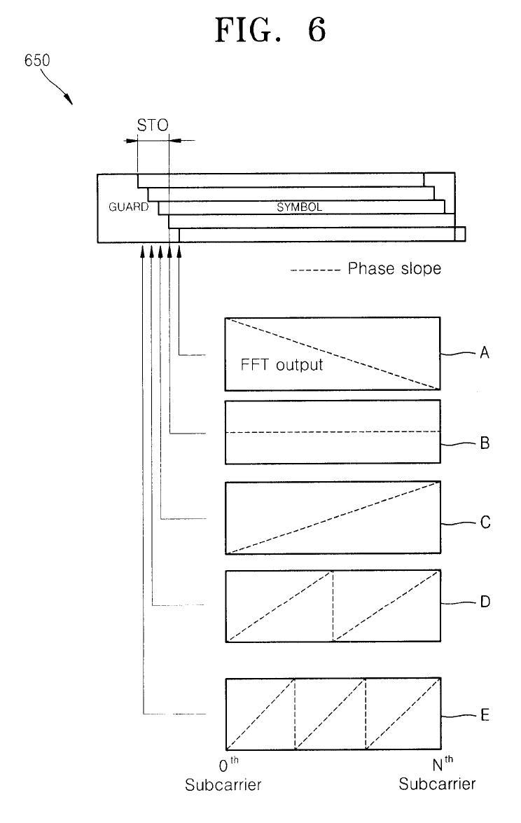

The maximum impulse response estimating unit 100 determines a maximum impulse response point with regard to a received OFDM signal, e.g., an OFDM symbol. The FFT start point estimating unit 200 detects a minimum symbol interference point with regard to the received OFDM signal and identifies or adjusts an FFT start point in the OFDM signal. The FFT operation performing unit 400 performs an FFT operation at the FFT start point identified or adjusted by the FFT start point estimating unit 200. The FFT operation results in a phase rotation based on the position of the FFT start point. This will be described in more detail with reference to FIG. 6.

The phase modifying unit 300 modifies a phase of an output of the FFT operation performing unit with the phrase rotation caused by the FFT operation. By modifying the phase of the output, the original phase of the FFT output can be obtained. The decoding unit 500 decodes the phase modified output of the FFT operation performing unit. An output of the decoded signal is input into the FFT start point estimating unit 200 and is used to estimate a more precise FFT start point.

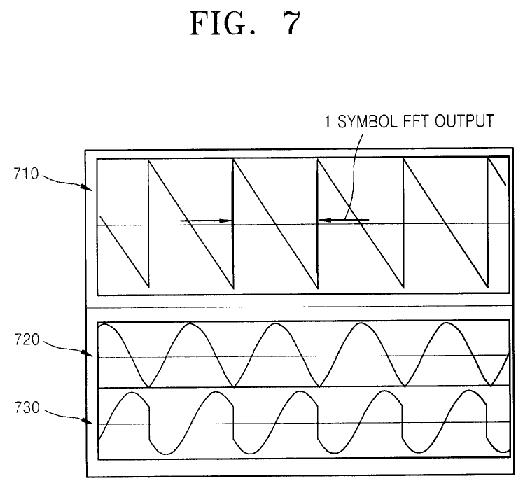

The phase modifying unit 300 generates a sine wave having phase information and outputs the generated sine wave to a multiplier to multiply the generated sine wave by the output of the FFT operation performing unit via complex conjugate multiplication so as to modify the phase of the output of the FFT operation performing unit. This will be described in more detail with reference to FIG. 7.

The OFDM receiving apparatus does not copy a symbol of a protection period, i.e. a guard symbol period. Rather, the OFDM receiving apparatus detects the minimum symbol interference point and performs the FFT operation from the detected minimum symbol interference point. Because the guard symbol period is not copied, a storage device or register is not needed, which provides the OFDM receiving apparatus with excellent area efficiency.

The phase modifying unit 300 of the OFDM receiving apparatus removes the phase rotation that occurs by adjusting the FFT start point. This allows the FFT operation as described in this specification to have the same result as the conventional method without having to use an additional storage device. The phase modifying unit 300 is shown in FIG. 3B.

The OFDM receiving apparatus may be applicable for all wireless broadcasting systems that use OFDM applications, such as DAB, DVB-H/T, DMB-H, DMB-T, wireless LAN, UWB, and the like.

FIG. 3B is a detailed block diagram 350 of an OFDM receiving apparatus (e.g., the OFDM receiving apparatus shown in FIG. 3A). Referring to FIG. 3B, the FFT start point estimating unit 200 includes a symbol timing shift estimating unit 210, an FFT start point adjusting unit 220, and a bit error rate (BER) calculating unit 230.

The BER calculating unit 230 calculates the BER of the output of the decoding unit 500. The symbol timing shift estimating unit 210 receives the outputs of the maximum impulse response estimating unit 100 and the BER calculating unit 230 and obtains a symbol timing shift representing a time difference between the maximum impulse response point and the minimum symbol interference point based on the length of a given guard symbol period. The FFT start point adjusting unit 220 receives an output of the symbol timing shift estimating unit 210 and adjusts the FFT start point of the FFT operation performing unit 400.

The phase modifying unit 300 includes a subcarrier index generating unit 310 that generates a subcarrier index and a numerically controlled oscillator (NCO) 320 that generates phase modifying signal, such as a sine wave. The subcarrier index generating unit 310 includes, for example, a counter that sequentially outputs numbers between −3408 and 3408 in an 8192 FFT mode of DVB-T.

Generally, the NCO 320 generates the sine wave used to remove a frequency shift of a symbol by multiplying the sine wave in a temporal axis before an FFT operation is performed. In the present embodiment, the NCO 320 also generates the sine wave to removes the phrase rotation of an FFT operation output. That is, the NCO 320 generates the sine wave using a value obtained by multiplying the symbol timing shift of the symbol timing shift estimating unit 210 by the index of the subcarrier index generating unit 310 as an address value, and removes the phrase rotation of an FFT operation output by multiplying a complex conjugate of the sine wave by the FFT operation output.

The NCO 320 generates the sine wave corresponding to the phase rotation by multiplying the symbol timing shift by the index, and automatically removes the phase rotation of the FFT operation output by multiplying the complex conjugate of the sine wave by the FFT operation output. The NCO 320 uses a clock frequency that is higher than a sampling clock frequency to generate the sine wave. The NCO 320 may be used to remove a frequency shift as stated above.

The decoding unit 500 includes a channel equalizing unit 510 that compensates for the characteristics of a distorted channel in the phase modified output of the FFT performing unit. The decoding unit 500 also includes a Viterbi decoding unit 520 that performs decoding on the output of the channel equalizing unit by using a convolution code. The decoding unit 500 includes a Reed-Solomon decoding unit 530 that performs decoding on the Viterbi decoded signal by using a Reed-Solomon code. The BER calculating unit 230 calculates a BER with respect to a signal that is decoded by the Reed-Solomon decoding unit 530.

The OFDM receiving apparatus may include a baseband converting unit 700 that converts a received OFDM signal into a baseband signal, an interpolation filtering unit 800 that samples an output signal of the baseband converting unit 700 and inputs the sampled signal into the FFT operation performing unit 400, and a clock error estimating unit 600 that estimates a clock error of the signal having the modified phase.

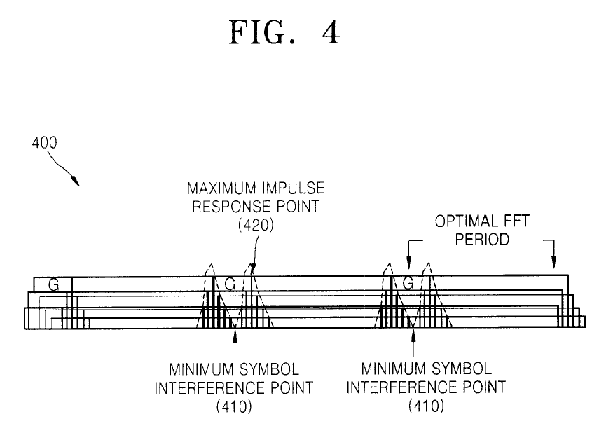

FIG. 4 is a diagram 400 illustrating a maximum impulse response point and a minimum symbol interference point of an OFDM symbol. Referring to FIG. 4, the minimum symbol interference point 410 of the OFDM symbol is included in a protection period before the maximum impulse response point 420. In general, the minimum symbol interference point is ¼ of the length of a guard symbol period from the maximum impulse response point. However, the minimum symbol interference point is not limited to this. The present disclosure searches for a precise minimum symbol interference point, and performs an FFT operation at the found minimum symbol interference point, thereby minimizing an ISI.

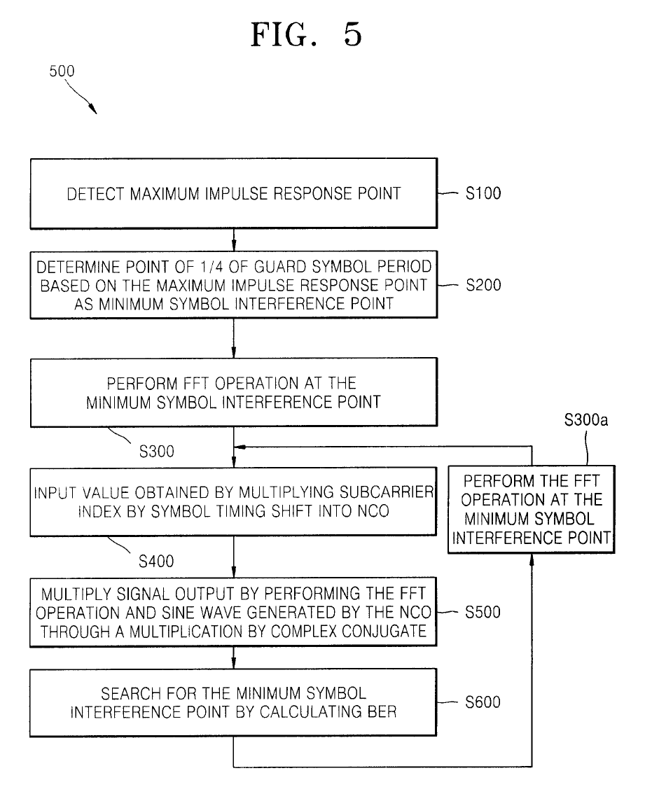

FIG. 5 is a flowchart 500 illustrating a method of minimizing an ISI according to an embodiment of the present disclosure. Referring to FIG. 5, the maximum impulse response estimating unit 100 determines a maximum impulse response point (S100). The FFT start point estimating unit 200 detects a minimum symbol interference point to be ¼ of a guard symbol period based on the maximum impulse response point (S200). Since the minimum symbol interference point is not directly detected at first, a point of ¼ of the guard symbol period from the maximum impulse response point is estimated as the minimum symbol interference point.

The FFT operation performing unit 400 performs an FFT operation at the minimum symbol interference point, i.e. the point of ¼ of the guard symbol period from the maximum impulse response point (S300). The NCO 320 receives as input, a value obtained by multiplying a subcarrier index by a symbol timing shift (S400). The NCO 320 generates a sine wave using the received value obtained by multiplying the subcarrier index by the symbol timing shift as an address value.

A signal output by performing the FFT operation and the sine wave generated by the NCO 320 are multiplied through a multiplication by a complex conjugate (S500). The NCO 320 restores a phase of the signal output of performing the FFT operation to an original phase (S500).

The BER calculating unit 230 calculates a BER and searches for an actual minimum symbol interference point (S600). Before operation S600 is performed, a signal having a restored phase is decoded. Thereafter, the FFT operation is performed at the found minimum symbol interference point (S300a). The process after performing S300a is the same as described above. That is, operations S400 through S600 are repeatedly performed. Such a feedback process makes it possible to more precisely search for the minimum symbol interference point, minimize the ISI, and actively handle a channel change to increase a receiving rate in various channel environments.

When synchronization is obtained, the maximum impulse response estimating unit 100 searches for the maximum impulse response point. Because the minimum symbol interference point is not exactly detected, the minimum symbol interference point before ¼ of the guard symbol period from the maximum impulse response point is determined as a base value. The minimum symbol interference point exists ¼ of the guard symbol period from the maximum impulse response point.

The FFT operation is performed by initially establishing the symbol timing shift as ¼ of the guard symbol from the maximum impulse response point. The FFT operation output results in a phase rotation by ¼ of the guard symbol. To remove the phrase rotation of the FFT operation output, a phase value that is to be restored at a frequency axis is obtained by multiplying the symbol timing shift by a subcarrier index.

The phase value is used as an address value of the NCO 320 to generate cosine/sine waves. The generated cosine/sine wave is multiplied to the FFT operation result through a multiplication by a complex conjugate so that the phase rotation of the FFT operation output is removed. After synchronization is obtained, the Viterbi decoding unit 520 and the Reed-Solomon decoding unit 530 output the BER. To detect the exact minimum symbol interference point, the BER calculating unit 230 searches a minimum BER point by moving a start point where the FFT operation is performed by one sample. A renewed symbol timing shift is applied to the NCO 320 to remove the phrase rotation of the FFT operation output.

FIG. 6 is a conceptual view diagram 650 for explaining the phase rotation of an FFT operation output after a FFT operation is performed by periods based on a maximum impulse response point. Referring to FIG. 6, a phase varies according to a point where the FFT operation is performed. When a second symbol is a reference symbol in which the phase rotation does not occur (B), when the FFT operation is performed after a sample, i.e. a symbol timing shift is 1, a phase slope or phase rotation shows that the phase is gradually reduced and the phrase is rotated by −360 degrees (A). When the FFT operation is performed before a sample, i.e. when the symbol timing shift is −1, the phase slope increases and thus the phase is rotated by 360 degrees (C.). Therefore, as a point where the FFT operation is performed moves forward, the phase slope gradually increases (C, D and E). STO is an acronym for symbol timing offset. The symbol timing offset or symbol timing shift is a difference between a point where the FFT operation is performed actually and a reference point in which the phase rotation does not occur.

Therefore, when the FFT operation is performed at a point other than the reference point, a phase rotation must be restored to an original phase by generating a sine wave corresponding to information about the phase rotation and multiplying the FFT operation output by the sine wave through a multiplication by a complex conjugate.

FIG. 7 shows graphs showing a phase slope and cosine/sine waveforms corresponding to the phase slope when a symbol timing shift is 1. Referring to FIG. 7, an upper graph 710 shows the phase slope when the symbol timing shift is 1, and two lower graphs 720 and 730 show the cosine and sine waveforms corresponding to the phase slope. The phase rotation is removed by multiplying a complex conjugate of the cosine or sine waves having phase information to a FFT output signal having the phase rotation.

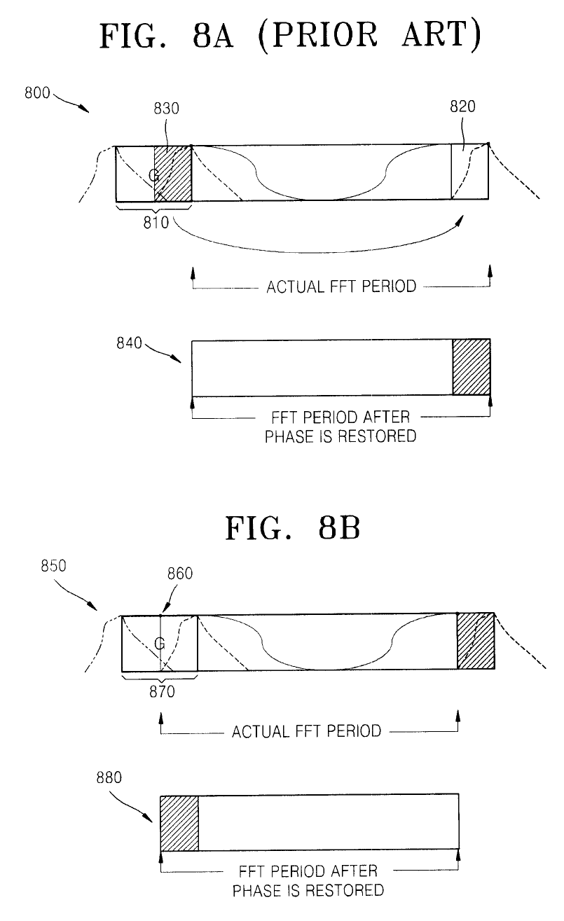

FIGS. 8A and 8B are conceptual views diagrams 800 and 850 for comparing a conventional method of removing an ISI and a method of removing the ISI according to an embodiment of the present disclosure, respectively.

Referring to FIG. 8A, the conventional method removes the ISI by copying a guard symbol part 810 and covering an end part 820 where IST occurs with the copied guard symbol part, i.e. a hashed line part 830. A lower part 840 indicates a FFT period where a phase is restored.

Referring to FIG. 8B, an FFT operation is performed at a minimum symbol interference point 860 of a guard symbol part 870. A lower part 880 is the FFT period where the phase is restored, which differs from the conventional FFT period. Although the conventional FFT period and the FFT period of the present disclosure are different from each other, since the guard symbol part is an additional part obtained by copying a valid symbol part, an FFT operation output has the same result. The conventional method requires an additional storage device or register for copying the guard symbol part, whereas the present disclosure does not need the additional storage device or register. Therefore, the OFDM receiving apparatus of the present disclosure has high area efficiency compared to the conventional method.

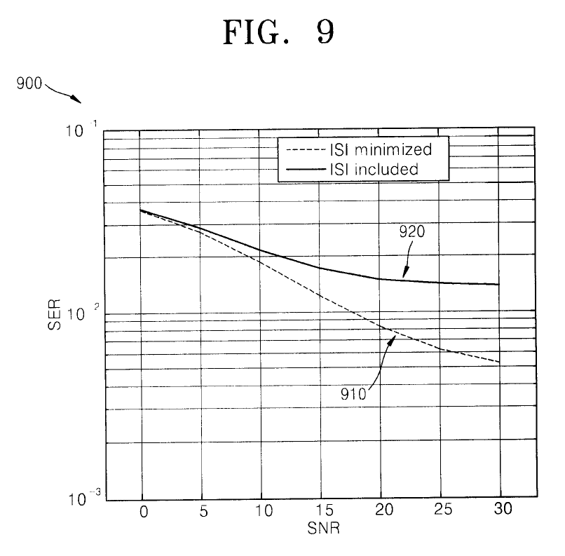

FIG. 9 is a graph 900 showing a symbol error rate (SER) with respect to a signal to noise rate (SNR) when the method of minimizing the ISI of the present disclosure is applied and is not applied. Referring to FIG. 9, a dotted line 910 is obtained by applying the described method of minimizing the ISI of the present disclosure, and a solid line 920 is obtained by not applying the method of minimizing the ISI of the present disclosure. The X-axis represents an SNR, and the Y-axis represents a SER.

When the method of minimizing the ISI of the present disclosure is applied, the graph 900 shows that the SER is dramatically reduced. As SNR increases, the SER is reduced when the method of minimizing the ISI of the present disclosure is applied. Thus, the method of minimizing the ISI of the present disclosure can be more efficiently utilized to a region where noise is greatly influenced.

An OFDM receiving apparatus and a method of minimizing an ISI using the OFDM receiving apparatus of the present disclosure output FFT from which a phase rotation is removed by using an NCO, so that the same result as the second conventional method is obtained, and an additional storage device or register is not required, thereby realizing an OFDM system having high area efficiency.

Also, the OFDM receiving apparatus and a method of minimizing an ISI using the OFDM receiving apparatus of the present disclosure search for a minimum symbol interference point by using a BER, thereby actively handling a channel change compared to the conventional method of fixing ¼ of a guard symbol period or a value through an experiment and increasing a receiving rate.

The NCO of the present disclosure can simultaneously remove a phase rotation of an FFT operation output and a frequency shift.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements, and variations can be made based on what is described and illustrated in this application.

What is claimed is:

1. An orthogonal frequency division multiplexing (OFDM) receiving apparatus comprising:
a fast Fourier transform (FFT) start point estimating unit to detect a minimum symbol interference point of a received OFDM signal and identify a FFT start point;
a FFT operation performing unit to communicate with the FFT start point estimating unit and to perform a FFT operation at the FFT start point identified by the FFT start point estimating unit;
a phase modifying unit to communicate with the FFT start point estimating unit and to modify a phase of an output of the FFT operation performing unit; and
a decoding unit to communicate with the FFT operation performing unit and to decode the phase modified output of the FFT operation performing unit,
wherein an inter-symbol interference (ISI) is minimized in the phase modified output of the FFT operation performing unit.

2. The apparatus of claim 1, comprising a maximum impulse response estimating unit to communicate with the FFT start point estimating unit to search for a maximum impulse response point in the OFDM signal.

3. The apparatus of claim 2, wherein the FFT start point estimating unit comprises:
a bit error rate (BER) calculating unit to receive an output of the decoding unit and calculate a BER of the output of the decoding unit;
a symbol timing shift estimating unit to communicate with the BER calculating unit and the maximum impulse response point estimating unit to receive the maximum impulse response point and an output of the BER calculating unit and estimate a symbol timing shift representing a time difference between the maximum impulse response point and the minimum symbol interference point; and
a FFT start point adjusting unit to communicate with the symbol timing shift estimating unit to receive an output of the symbol timing shift estimating unit and adjust the FFT start point of the FFT operation performing unit.

4. The apparatus of claim 3, wherein the FFT start point estimating unit is configured to detect the minimum symbol interference point by using the calculated BER.

5. The apparatus of claim 3, wherein the phase modifying unit comprises: a subcarrier index generating unit to generate an index of a subcarrier; and
a numerically controlled oscillator (NCO) to generate a phase modifying signal using a value obtained by multiplying an output of the symbol timing shift estimating unit and an output of the subcarrier index generating unit as an address value.

6. The apparatus of claim 5, wherein the generated phase modifying signal comprises a sine wave.

7. The apparatus of claim 5, wherein the phase modifying unit modifies the phase of the output of the FFT operation performing unit by multiplying a complex conjugate of the generated phase modifying signal with the output of the FFT operating performing unit.

8. The apparatus of claim 5, wherein the generated phase modifying signal used to modify the phase of the output of the FFT operation performing unit is generated based on a clock signal that is higher than a sampling clock signal, and
the generated phase modifying signal is used to remove a frequency shift of the received OFDM signal.

9. The apparatus of claim 3, wherein, when the FFT start point is initially identified, the FFT start point estimating unit estimates a point before the maximum impulse response point of the OFDM signal by using a predetermined period of a guard symbol as the FFT start point.

10. The apparatus of claim 1, wherein the FFT start point estimating unit is configured to actively detect the minimum symbol interference point in response to a channel change through a feedback operation.

11. The apparatus of claim 2, further comprising:
a baseband converting unit to convert the OFDM signal into a baseband signal;
an interpolation filtering unit to communicate with the baseband converting unit and the FFT operation performing unit, wherein the interpolation filtering unit is configured to sample an output of the baseband converting unit and input the sampled output into the FFT operation performing unit; and
a clock error estimating unit to estimate a clock error of the phase modified output of the FFT operation performing unit.

12. The apparatus of claim 1, wherein the decoding unit comprises:
a channel equalizing unit to compensate for characteristics of a distorted channel in the phase modified output of the FFT performing unit;
a Viterbi decoding unit to communicate with the channel equalization unit to decode an output of the channel equalization unit using a convolution code; and
a Reed-Solomon decoding unit to communicate with the Viterbi decoding unit to decode an output of the Viterbi unit using a Reed-Solomon code.

13. A method of minimizing an inter-symbol interference (ISI), the method comprising:
detecting, at a maximum impulse response estimating unit, a maximum impulse response point of an orthogonal frequency division multiplexing (OFDM) signal;
estimating, at a fast Fourier transform (FFT) start point estimating unit, a minimum symbol interference point in the OFDM signal;
performing, at a FFT operation performing unit, a FFT operation at the estimated minimum symbol interference point;
modifying a phase of an output of the FFT operation performing unit; and
decoding, at a decoding unit, the phase modified output of the FFT performing unit.

14. The method of claim 13, wherein when initially performing the FFT operation, estimating, at the FFT start point estimating unit, a point before the maximum impulse response point of the OFDM signal by using a predetermined period of a guard symbol as the minimum symbol interference point.

15. The method of claim 13, wherein modifying the phase comprises generating a phase modifying signal and applying the generated phase modifying signal to the output of the FFT operation performing unit,
wherein the phase modifying signal comprises a sine wave signal generated by an NCO using a value obtained by multiplying a symbol timing shift representing a time difference between the maximum impulse response point and the minimum symbol interference point and a subcarrier index as an address value, and
a complex conjugate of the sine wave is multiplied with the output of the FFT operating performing unit.

16. The method of claim 15, wherein modifying the phase comprises using the sine wave to modify the phase, and generating the sine wave, at the NCO, by using a clock signal that is higher than a sampling clock signal.

17. The method of claim 13, wherein decoding the phase modified output of the FFT performing unit comprises:
compensating, at a channel equalizing unit, for characteristics of a distorted channel in the phase modified output of the FFT performing unit;
decoding, at a Viterbi decoding unit, an output of the channel equalizing unit by using a convolution code; and
decoding, at a Reed-Solomon decoding unit, an output of the Viterbi decoding unit by using a Reed-Solomon code.

18. The method of claim 15, further comprising:
after decoding the phase modified output of the FFT performing unit, calculating, at a bit error rate (BER) calculating unit, a BER of the output of the decoding unit.

19. The method of claim 18, comprising:
actively detecting the minimum symbol interference point in response to a channel change through a feedback operation that uses the BER calculated by the BER calculating unit in estimating the minimum symbol interference point.

20. The method of claim 18, further comprising:
before estimating the minimum symbol interference point, estimating, at a symbol timing shift estimating unit, the symbol timing shift representing a time difference between the maximum impulse response point and the minimum symbol interference point;
estimating the minimum symbol interference point using an output of the symbol timing shift estimating unit, and estimating the symbol timing shift using the outputs of the maximum impulse response estimating unit and the BER calculating unit.
